(19) United States
(12) Patent Application Publication
(10) Pub. No.: US 2012/0303466 A1
(43) Pub. Date: Nov. 29, 2012

(54) Shape-Based Advertising for Electronic Visual Media

(75) Inventor: Adam Boskovich, San Diego, CA (US)

(73) Assignee: WowYow, Inc., San Diego, CA (US)

(21) Appl. No.: 13/472,406

(22) Filed: May 15, 2012

Related U.S. Application Data
(60) Provisional application No. 61/490,894, filed on May 27, 2011.
(60) Provisional application No. 61/536,535, filed on Sep. 19, 2011.

(51) Int. Cl. G06Q 30/02

(52) U.S. Cl. 705/14.72

(57) ABSTRACT

Shape-based advertising techniques and systems are presented. A piece of visual media may be used to present advertising to the viewer of the media. Shapes within the visual media may be targeted, highlighted or otherwise identified for any type of advertising association, and then such advertising can be presented to the viewer of the media while viewing the media.

### CLAIM OF PRIORITY

This application claims the benefit of priority from U.S. Provisional Patent Application Ser. No. 61/490,894, entitled “Shape-Based Advertising for Visual Media” and filed on May 27, 2011, and from U.S. Provisional Patent Application Ser. No. 61/536,535, entitled “Shape-Based Advertising from Visual Media” and filed on Sep. 19, 2011, both of which are incorporated herein by reference for all purposes.

### BACKGROUND

The application is generally related to multimedia advertising and, more particularly, to shape-based advertising for visual media.

### SUMMARY

Shape-based advertising techniques and systems are presented. A piece of visual media may be used to present advertising to the viewer of the media. Shapes within the visual media may be targeted, highlighted and identified for any type of advertising.

In certain embodiments, a method for shape-based advertising for electronic visual media is presented, which can include capturing the electronic visual media, identifying the electronic visual media information associated with the electronic visual media, communicating the electronic visual media information, analyzing the electronic visual media information for association with the shape-based advertising, and presenting the shape-based advertising together with the electronic visual media on an electronic device.

In certain embodiments, a system for shape-based advertising for electronic visual media is presented, which can include a media player for capturing the electronic visual media and identifying the electronic visual media information associated with the electronic visual media, a promotional information server for receiving the electronic visual media information, and a promotional information calculator for analyzing the electronic visual media information for association with the shape-based advertising, wherein the media player presents the shape-based advertising together with the electronic visual media on an electronic device.

In certain embodiments, an apparatus for shape-based advertising for electronic visual media is presented, which can include means for capturing the electronic visual media, means for identifying the electronic visual media information associated with the electronic visual media, means for communicating the electronic visual media information, means for analyzing the electronic visual media information for association with the shape-based advertising, and means for presenting the shape-based advertising together with the electronic visual media on an electronic device.

In certain embodiments, a computer-program storage apparatus for shape-based advertising for electronic visual media is presented, which can include at least one memory that can have one or more software modules stored thereon, the one or more software modules can be executable by one or more processors and the one or more software modules can include code for capturing the electronic visual media, code for identifying the electronic visual media information associated with the electronic visual media, code for communicating the electronic visual media information, code for analyzing the electronic visual media information for association with the shape-based advertising, and code for presenting the shape-based advertising together with the electronic visual media on an electronic device.

In certain embodiments, a method for shape-building for shape-based advertising for electronic visual media is presented, which can include selecting a frame of the electronic visual media, building a shape associated with the frame of the electronic visual media, and adding shape entries for the built shape.

In certain embodiments, a system for shape-building for shape-based advertising for electronic visual media is presented, which can include a selector apparatus for selecting a frame of the electronic visual media, a builder apparatus for building a shape associated with the frame of the electronic visual media, and an adder apparatus for adding shape entries for the built shape.

In certain embodiments, an apparatus for shape-building for shape-based advertising for electronic visual media is presented, which can include means for selecting a frame of the electronic visual media, means for building a shape associated with the frame of the electronic visual media, and means for adding shape entries for the built shape.

In certain embodiments, a computer-program storage apparatus for shape-building for shape-based advertising for electronic visual media is presented, which can include at least one memory that can have one or more software modules stored thereon, the one or more software modules can be executable by one or more processors and the one or more software modules can include code for selecting a frame of the electronic visual media, code for building a shape associated with the frame of the electronic visual media, and code for adding shape entries for the built shape.

In certain embodiments, a method for advertising for electronic visual media on a web-page, is presented, which can include determining at least one electronic visual media identifier (ID) for the electronic visual media, selecting at least one shape-based advertisement based at least on the electronic visual media ID, selecting at least one web-page advertisement based at least on the electronic visual media ID, presenting the at least one shape-based advertisement in conjunction with presenting the electronic visual media, and presenting the at least one advertisement on the web-page in conjunction with presenting the electronic visual media.

In certain embodiments, a system for advertising for electronic visual media on a web-page, is presented, which can include a video player for determining at least one electronic visual media identifier (ID) for the electronic visual media, a server for selecting at least one shape-based advertisement based at least on the electronic visual media ID and for selecting at least one web-page advertisement based at least on the electronic visual media ID, an apparatus for presenting the at least one shape-based advertisement in conjunction with presenting the electronic visual media, and an apparatus for presenting the at least one advertisement on the web-page in conjunction with presenting the electronic visual media.

In certain embodiments, an apparatus for advertising for electronic visual media on a web-page, is presented, which can include means for determining at least one electronic visual media identifier (ID) for the electronic visual media, means for selecting at least one shape-based advertisement based at least on the electronic visual media ID, means for selecting at least one web-page advertisement based at least on the electronic visual media ID, means for presenting the at least one shape-based advertisement in conjunction with presenting the electronic visual media, and means for presenting the at least one advertisement on the web-page in conjunction with presenting the electronic visual media.

In certain embodiments, a computer-program storage apparatus for advertising for electronic visual media on a web-page is presented, which can include at least one memory that can have one or more software modules stored thereon, the one or more software modules can be executable by one or more processors and the one or more software modules can include code for determining at least one electronic visual media identifier (ID) for the electronic visual media, code for selecting at least one shape-based advertisement based at least on the electronic visual media ID, code for selecting at least one web-page advertisement based at least on the electronic visual media ID, code for presenting the at least one shape-based advertisement in conjunction with presenting the electronic visual media, and code for presenting the at least one advertisement on the web-page in conjunction with presenting the electronic visual media.

### BRIEF DESCRIPTION OF THE DRAWINGS

FIG. 1 illustrates an exemplary system overview according to certain embodiments;

FIG. 2 illustrates an exemplary visual media image before shape-based advertising according to certain embodiments;

FIG. 3 illustrates an exemplary visual media image after shape-based advertising according to certain embodiments;

FIG. 4 illustrates an exemplary process of shape-based advertising according to certain embodiments;

FIG. 5 illustrates an exemplary hardware implementation of shape-based advertising according to certain embodiments;

FIG. 6 illustrates an exemplary screen-shot depicting a shape-builder program input-screen according to certain embodiments;

FIG. 7 illustrate exemplary screen-shots depicting shape-based advertisement entry screen and inventory entry screen according to certain embodiments;

FIG. 8 illustrates an exemplary process of shape building for shape-based advertising according to certain embodiments;

FIG. 9 illustrates an exemplary hardware implementation of shape building for shape-based advertising according to certain embodiments;

FIG. 10 illustrates an exemplary system and process for temporal-based, visual media advertising according to certain embodiments;

FIG. 11 illustrates an exemplary process for visual media-based advertising according to certain embodiments; and

FIG. 12 illustrates an exemplary hardware implementation for visual media-based advertising according to certain embodiments.

### DETAILED DESCRIPTION

The following detailed description is directed to certain embodiments. However, the disclosure can be embodied in a multitude of different ways, as will be evident to those skilled in the art from the teaching of this disclosure, together with the accompanying drawings, all of which and their equivalents are intended to be covered within the scope of the claims. In this description, reference is made to the drawings wherein like parts are designated with like reference numerals throughout.

Throughout this specification, reference will be made to a frame of a video stream. However, those skilled in the art will understand that the techniques taught herein are equally applicable to a single image (e.g., JPEG, GIF, TIF, BMP, etc.) and/or any multi-image compilation (e.g., a slideshow, gallery, album, etc.), as well as to individual frames and sets of frames of a video stream. As used herein, either alone or in combination with other words, the term “frame” may refer to a picture, a frame, a field or a slice thereof. The claims are intended to cover the disclosed shape-based advertising techniques for any visual media currently known in the art, or that may be developed and applicable in the future.

### Introduction

Visual media have always grabbed our attention, from the earliest days when humans first created drawings on cave walls, to modern times with streaming live video on our smart phones. As visual media have evolved, so have the ways in which marketers and advertisers have used visual media to sell everything.

The first marketers used word-only visual advertisements in early newspapers and magazines, which was followed by graphical ads and picture ads in these same printed periodicals. These types of printed advertisements naturally spilled over into direct household mailings. With the invention of the automobile, text and graphic billboards sprung up along the newly created roadsides. When movies and televisions became commonplace, so did advertisements using product placement and video clips in addition to text and graphics.

More recently, as Internet-connected computers became household appliances (and vice versa), so did computer-based advertising. Marketers use a myriad of ways, some controversial and some not, via computers to present products and services to users. Webpages use banner ads, pay-for-placement ads and pop-up ads to generate revenue through advertising. And just as printed periodical advertisements found their way into our mailboxes, electronic advertisements have inundated our electronic mail inboxes. Today, with different wireless networks all around, and a multitude of portable devices capable of connecting and interconnecting via those myriad wireless networks, the possible ways of receiving advertisements seems endless.

However, all of these historic and more modern types of advertising rely on planning and creating the text, graphics and/or video to use specifically for the marketed product or service and the targeted audience. This type of advertising is very costly and time consuming to make and may not reflect the consumer's day-to-day reality. The techniques presented in this application use any existing or purposefully-created visual media to facilitate advertising anything. Advertising using the techniques taught herein may be for products and/or services shown within or somehow related to the visual media, and/or somehow related to the particular viewer and/or creator of the visual media. In fact, anything may be advertised or marketed or even just presented using the techniques and systems presented in this application.

Once created, for example using any kind of a video-recording device (e.g., smart phone, camera, camcorder, webcam, etc.) or visual media creation process (e.g., simulation, animation, presentation, video game creation, etc.), a video stream must be somehow presented to a user for viewing. With modern interconnectivity, this video presentation often involves digitally transmitting the video to the user over the Internet and/or using some wired or wireless capability. Videos may also be presented in an analog manner via wired or wireless methods. Additionally, videos may be transmitted to the user for view via some kind of storage device (e.g., compact disc, thumb drive, mini-disc, etc.).

Once transmitted, a coded video stream will be decoded and presented to a user for viewing. The presented video stream may have certain characteristics, such as visual dimensions and time components. The visual dimensions may be specific to the media itself, the media player and/or the display device. For example, the media itself may have a natural height and width, and height/width ratio, or aspect ratio, while the media player may be able to accept and output multiple height/width/aspect combinations, yet the display device requires a particular height/width/aspect combination. A conversion process or calculation can resolve these dimensional disparities. Each of these height/width combinations may be used with certain techniques disclosed herein.

A third dimensional property of the video is placement within the whole of the display device. In certain embodiments, the video may only take up a small portion of the total visual area of the display device, in which case the placement of the video within the display device may be defined. For example, a corner of the video player area may be defined by an x-y coordinate, and then a height/width provided (e.g., in pixels, inches, etc.) that adds to this starting point (e.g., x+100, y+200). In this way, certain techniques disclosed herein may know where within the total display area the video and advertising may be shown.

Time components of the video stream can include several elements. The video itself may have an inherent length of time to it. The video may be five (5) minutes or five (5) hours long. Further, each video frame will have a time of presentation within the video length, which may be provided or derived from the frame order number and display frame rate. The video length and/or frame presentation time may be used for certain display functions, like pause, play, stop, fast-forward, rewind and so on. Another time element is when the video starts, or time in space, such as when a particular television show begins and/or ends. Also, an instance in time may be provided or derived, such as the actual time right now, or the actual video time (or frame number) of the current frame being displayed. Each of these time components or elements, and the dimensions discussed above, may be stored, recalled and otherwise used by certain embodiments disclosed in this application.

The user may be on a wired or wireless network, or may be off any network viewing the content from pre-downloaded material or from a loaded (or pre-loaded) storage device. The device being used may be virtually any type of equipment capable of visually presenting the video stream to the user. These devices may include televisions, monitors, set-top/cable boxes, digital video recorders, video disc players, computers, laptops, netbooks, smartbooks, personal digital assistants, personal video players, electronic book readers, smart phones, tablets, cell phones, and any similar type of equipment.

### System Overview

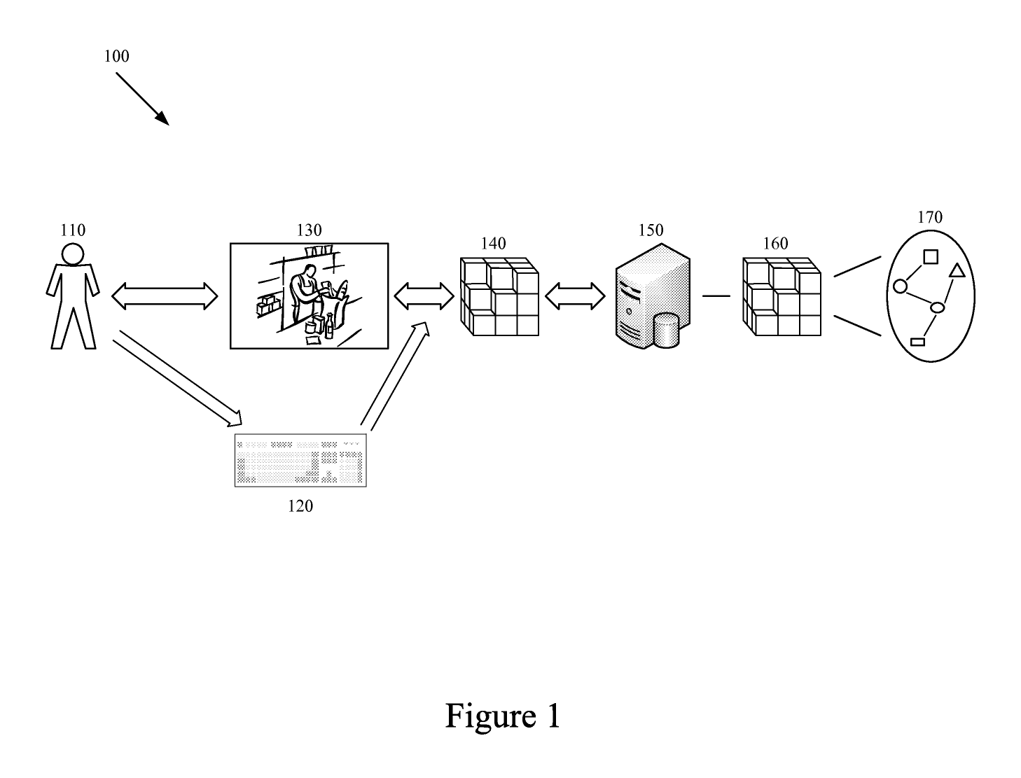

FIG. 1 illustrates an exemplary system overview 100 according to certain embodiments. As shown in FIG. 1, a system user, or viewer or watcher, 110 will interact with system 100, providing input and receiving output. Alternatively, the input/output capabilities of user 110 may be automated. User 110 may provide input to system 100 via an input device 120. As used herein, user 110 may be a shape builder, an advertisement creator, an inventory manager, an end-user, a system administrator, or any other similar type actor within system 100 as disclosed herein. Input device 120 may be any type of device suitable for supplying instructions, executing or initializing commands and/or providing responses into system 100. Such devices may be a keyboard (shown), a mouse, a touch pad, a joystick, a video touch screen, a remote controller, a game controller, a voice command receiver, a motion detector, buttons or knobs, and the like, and may be wired, wireless and/or integrated with other system 100 parts or components.

User 110 may receive output from (and may provide input to) system 100 via a visual media display device 130. Display device 130 may be any type of equipment that is at least capable of facilitating visual interaction with user 110, such as a television, a monitor, a computer or laptop screen, a smart phone screen, a touch screen, a projector, and the like.

Both or either of input device 120 and display device 130 also may be capable of interacting with a visual media computing device 140. This (or these) interaction(s) may be external via a wired or wireless connection (e.g., television connected to a digital video machine or game console) or may be internal to one or more integrated pieces of equipment (e.g., a smart phone, tablet or laptop). Computing device 140 is capable of supplying visual media information for display to user 110 via display device 130, and also is capable of receiving input from user 110 via either (or both of) input device 120 and/or display device 130. Further, computing device 140 is capable of managing and controlling what, when and how visual media are supplied to display device 130, and as such may be considered the graphical interface between display device 130 and the remainder of system 100. For example, computing device 140 may be capable of decoding video streams, converting from/to various height/width/aspect combinations, define video presentation placement and area, keep track of video start time, specific frame presentation time, video length, and so on. Computing device 140 also may be capable of storing visual media information, such as programmed input prompts and/or responses to such prompts, and running stored programs relating to the visual media.

Computing device 140 can connect to a promotional information server 150, via a wired or wireless connection, such as a LAN, WAN WiFi, WiMAX, Internet, Intranet, 4G Broadband, DSL, dial-up, cable, satellite, USB, Ethernet, etc. network. Any type of network connection suitable for use between computing device 140 and information server 150 can work. Promotional information server 150 in general can include computing capabilities, using one or more processing units, connected to internal or external memory. Certain techniques of this disclosure may be included in programs, software code or modules stored in the memory of information server 150 and executed by the processing unit(s). Such code may include one or more databases and/or file systems, along with communication capabilities and graphical data coding capabilities for supplying visual media information to computing device 140. As shown, promotional information server 150 is single server. However, information server 150 may be multiple servers or similar devices providing server-like functionality, which may be collocated with each other or distributed across multiple locations.

Integral to, or separate from, promotional information server 150, yet in communication with it, is a promotional information calculator 160, which is capable of performing promotional calculations 170 to facilitate the shape-based advertising disclosed within this application. Information calculator 160 can execute programs, software code or modules, including machine instructions for a programmable processor, which may be implemented in one or more high-level programming languages and stored in memory for information calculator to use.

The components of system 100 are shown as being separate and distinct for illustrative and/or functionally descriptive purposes only. Some or all of the functions performed by any one or all of the components of system 100 may be combined with any other of the components. Showing separation of these components is strictly a matter of convenience, to facilitate an easier understanding of this description.

### Shape-Based Advertising

At a high level and in certain embodiments, shape-based advertising may include the idea of, starting with a piece of visual media, mapping the shapes within the media to particular items that may be relevant and associated as advertising. Then, when that particular piece of visual media is shown to a user or viewer, the mapped shapes along with advertising prompts are also shown to the user. In this manner, any visual media may be a source for advertising anything within the media, or associated to it, and potentially anything at all.

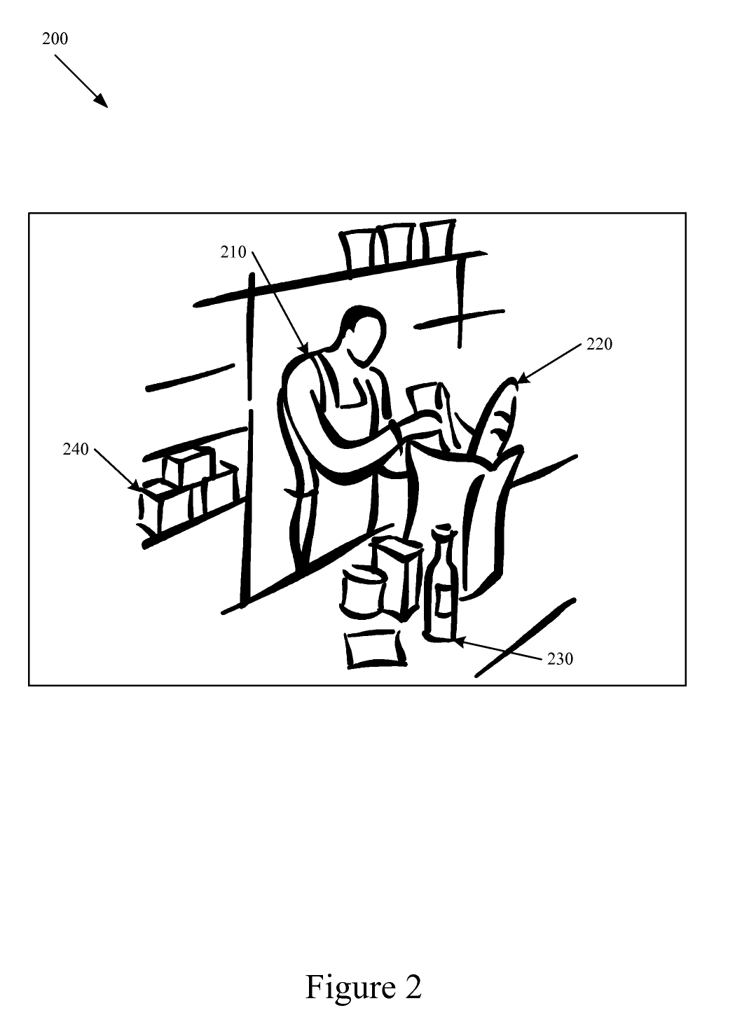

FIG. 2 illustrates an exemplary visual media image 200 before shape-based advertising according to certain embodiments. As shown in FIG. 2, visual media image 200 generally depicts a marketplace scene. In media image 200, a clerk wearing an apron 210 standing behind a counter is placing items in a grocery bag, like a loaf of bread 220, with some items still on the counter, like a bottle 230, and other items remaining on the shelves in the background, like a box 240. Visual media image 200 may be one frame or field of a video image (e.g., a movie, television show, Internet video, etc.), or may be a separate picture (e.g., stand-alone shot, one of a slideshow or gallery, etc.), or any other type of visual image.

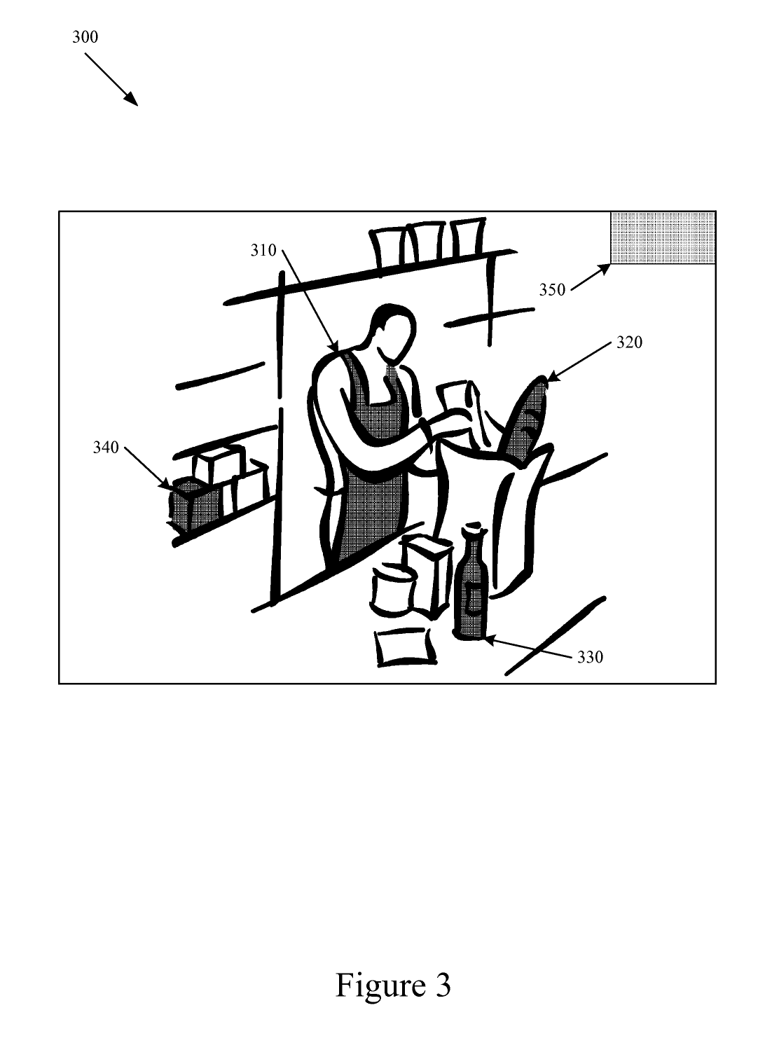

FIG. 3 illustrates an exemplary visual media image 300 after shape-based advertising according to certain embodiments. As shown in FIG. 3, which depicts the same scene as shown in FIG. 2, certain items in media image 300 appear highlighted: the apron 310, the bread 320, the bottle 330 and the box 340. Additionally a separate advertising area 350 may be used, which may be a not associated with any particular item in the scene, but generally relate to the scene, video, creator, website, etc. (or perhaps be completely random advertising). Advertising area 350 may be anywhere within the scene, or not included at all. The item highlighting may be a different color, a bolder outline, an area fill pattern, a flashing line or file pattern/color, any combination of these, or any visual distinction that will indicate to the user or viewer that those particular items have advertising associated with them.

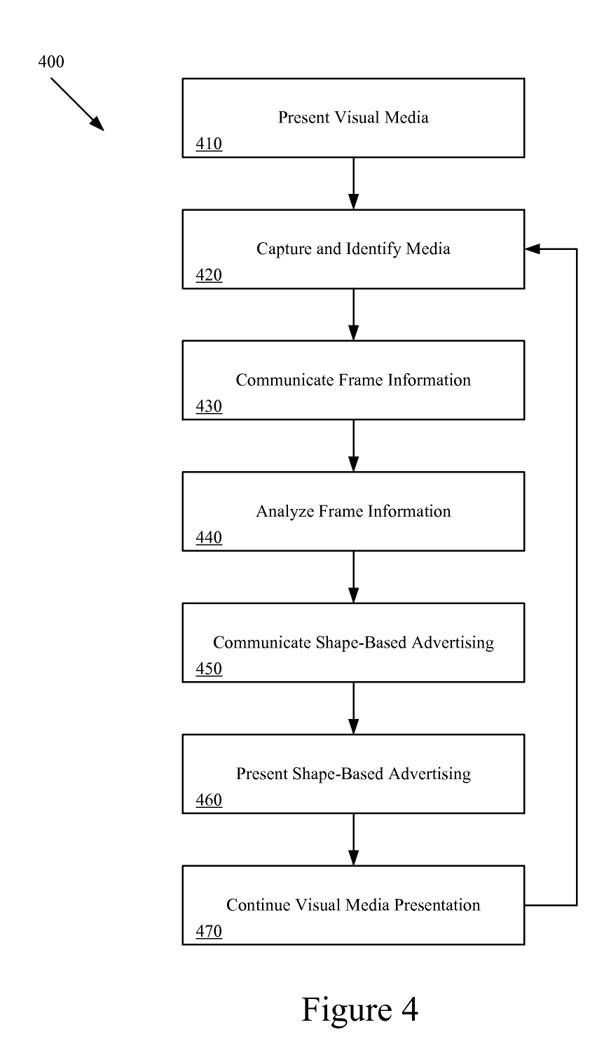

FIG. 4 illustrates an exemplary process 400 of shape-based advertising according to certain embodiments. Initially, at step 410, a piece of visual media is presented to user 110 on display device 130. In certain embodiments, the presentation may be via a media player as part of computing device 140. The visual media may be variably accessible by the media player. Additionally, the media player may be capable of identifying, storing and/or communicating within system 100 the unique identifier of the particular visual media being presented, as well as the various visual dimensions and/or time components of visual media being presented, as might be necessary to facilitate shape-based advertising.

At step 420, the piece of visual media is captured and identified. In certain embodiments, the media player may capture the visual media by pausing it with input from user 110 via input device 120. Alternatively, or in addition to, the capture might be automatic or pre-programmed into the visual media, for example, to present to user 110 shape-based advertising when a particular frame (or frames) of a video stream is reached or at pre-determined intervals of a video stream. In certain embodiments, an automatic capture may not hinder the video presentation at all, as a pause function might, but may be handled internally for only as long as the frame (or frames) is normally displayed on display device 130, in normal, slow, fast-forward, rewind, etc. mode. In this way, the capture is not necessarily a media player function, but an internal visual capture or recognition, for which the scope of the claims in intended to cover. If the visual media being presented is not a video, but instead some sort of picture, then the capture may not be necessary, or may happen, but have a superfluous effect. With the piece of visual media captured, the particular frame being displayed on display device 130 and be further identified.

At step 430, certain frame information is communicated. In certain embodiments, the media player may communicate frame information with promotional information server 150. The frame information might include the unique identifier of the particular visual media being presented (which might include the content, subject matter, etc. of the media as might be included in meta-data for the media), the frame number currently being displayed, other visual dimensions of the frame and visual media and/or time components of the frame and visual media. Alternatively, or in addition to, the frame information might include the frame itself, encoded or not, for downstream analysis.

At step 440, the communicated frame information is analyzed for possible shape-based advertising. In certain embodiments, promotional information server 150 in conjunction with promotional information calculator 160 and promotional calculations 170 may perform the analysis of the frame information. The frame information analysis can include searching a database using the visual media identifier and frame number to associate promotional information stored in the database with that particular frame. The promotional information (the origins of which are discussed in more detail, below) may include one or more shape overlays that correspond to certain shapes in the identified and associated frame.

The shape overlay may include coordinates of points within the frame that define the external boundaries of the shape. For example, the pattern of the shape may be defined by a series of x-y coordinate points within the frame “x1-y1, x2-y2, x3-y3, x4-y4, x5-y5, etc.” These x-y coordinate points may start and end with the same point, thereby defining the shape, or the particular programming language used may assume the last point is the next-to-last point and auto-connect it to the starting point, thereby defining the shape. For standard shapes (e.g., circle, square, triangle, etc.) a more shorthanded approach to shape definition might be used. For example, a circle might be defined by a center x-y point and a radius, or a square might be defined by a starting x-y corner and a side length. Shapes may also be defined by a combination of other shapes.

The code below provides two examples of different shape-defining code.

```
<area shape=”polygon” coords=”x1,y1,x2,y2,x3,y3,x4,y4,x5,y5,x1,y1”
  id=“4” category=clothing/>
<area shape=”polygon” coords=”x1,y1,x2,y2,x3,y3,x4,y4,x5,y5” id=“4”
  category=clothing/>
```

As can be seen, in the first example, the last x-y coordinate is the starting point (or the first x-y coordinate), which closes the polygon shape, and in the second example it is not. In the second example code, the language used will presume that the last point in the list is reconnected to the first point in the list, thereby defining, or closing, the polygon shape. It should be noted that, while a closed shape (e.g., a polygon) is used for both of these examples, the disclosed shape-based advertising may also work with unclosed shapes, such as lines, arcs, zigzags and so on.

In certain embodiments at step 440, analyzing the frame information can include correlating the shape-based advertising to the frame. For example, if the frame is being viewed on display device 130 at a width and height of 1024×576 pixels, but the associated promotional information has been created and/or stored at a width and height of 640×480 pixels (or, stored at a size larger than what is being viewed on display device 130), basic resolution and/or aspect ratio conversion may be performed to correlate the promotional information (e.g., the shape overlays, identifying ad information, etc.) with the frame as it will be used on display device 130. These conversions and/or correlations may be performed by promotional information server 150 in conjunction with promotional information calculator 160 and/or promotional calculations 170.

At step 440, the one or more shape overlays may also be identified with advertising information, such as an Internet address of the advertiser or a shopping sight to purchase the item represented by the shape overlay (i.e., a buy-link), general contact information, a coupon or promotion code, a barcode or QR code, and anything else an advertiser might want to present to a viewer of that shape in that frame of that visual media. In certain embodiments, buy-links may be static and created and/or stored with each particular shape overlay for that particular frame, or maybe be more dynamic in nature, where buy-links may be associated with a certain shape, regardless of in what frame that shape may appear, and then shape information is used to dynamically pull in buy-links for that particular frame. Details of overlay shape creation and advertising information identification will be discussed in more detail, below.

At step 450, once the frame information is analyzed and, as needed, correlated with promotional information, the shape-based advertising is communicated. In certain embodiments, promotional information server 150 communicates the shape-based advertising to visual media computing device 140. At step 460, the shape-based advertising is presented. In certain embodiments, computing device 140 presents the shape-based information for display to user 110 on visual media display device 130. In this way, user 110 will see a frame with certain shapes highlighted (as previously discussed with reference to FIG. 2 and FIG. 3), which will indicate advertisements are available and associated with the highlighted shapes. As used herein, the word highlight is intended to mean any type of visual differentiation of one component of the media as contrasted with that component in an un-highlighted state such that user 110 might be alerted to possible advertising associated with the highlighted component.

At step 470, the visual media presentation may be continued. In certain embodiments, the continuing presentation may be via the media player of computing device 140. The continuing of the presentation may be after some user 110 interaction via input device 120 and/or after some automatic or semi-automatic event, such as after a certain amount of time has passed. The exemplary process may be repeated after continuing presentation of the visual media by passing control to step 420, where the piece of visual media (or a new piece of media) may again be captured and identified, and so on.

As discussed above with reference to FIG. 4, shape-based advertising may be performed, in a software sense, external to display device 130 and computing device 140 (but, of course, may be integrated into a single system). For example, dynamic linked libraries, classes, modules may interact and/or communicate from disparate locations and/or separate equipment. However, certain embodiments can use a completely, or partially, internal solution (again, “internal” in a software sense). In this internal solution, computing device 140 may include a visual media player and a figure creator (or an automated figure creator) with an advertising module, which all may be compiled into a single software file (or multiple files) using, for example, Flash. In certain embodiments, computing device 140 may play a video and also create the advertising shape(s) for displaying to user 110 using, for example, ActionScript, and/or objects in the video timeline. Depending on the visual media being presented and the system configuration, the advertising associated to the derived advertising shapes may be stored locally, as part of the media file itself, may be pre-loaded via a wired or wireless connection and stored for later use, or may be retrieved in a real-time or near-real-time manner.

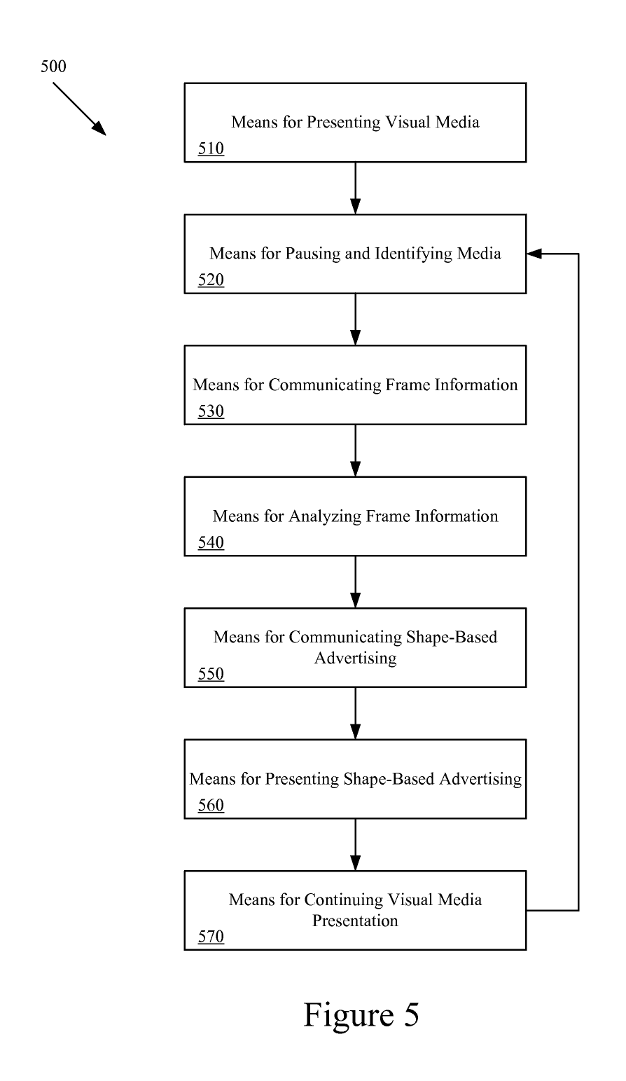

FIG. 5 illustrates an exemplary hardware implementation 500 of shape-based advertising according to certain embodiments. As shown in FIG. 5, blocks 510-570 correspond to hardware implementation of the exemplary process illustrated in steps 410-470 and the corresponding disclosure. Some or all of block 510-570 may be performed by hardware disclosed throughout this application, either with or without accompanying software/firmware/code, or other hardware as may be equivalent to the disclosed hardware.

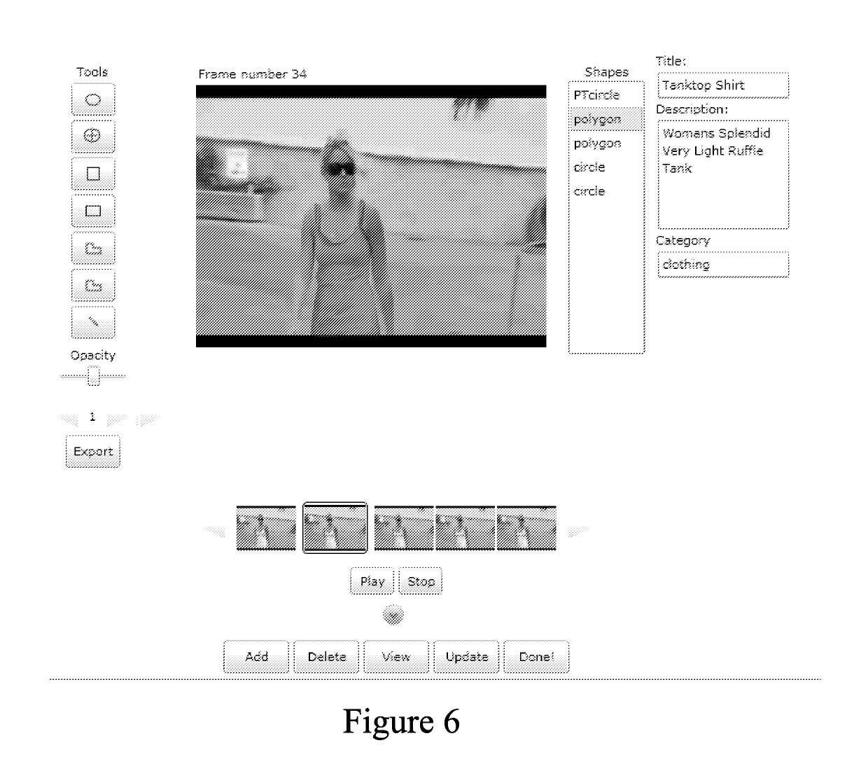

FIG. 6 illustrates an exemplary screen-shot depicting a shape-builder program input-screen according to certain embodiments. As shown in FIG. 6, the shape-builder program can be used to define shape overlays for a particular piece of visual media (e.g., such as the shape overlays shown in FIG. 3). The shape builder program presents the visual media such that shape overlays may be created, defined, identified and/or stored for use in certain embodiments of the shape-based advertising discussed herein.

In certain embodiment, the shape-builder program provides for displaying the visual media, such as playing, at variable speeds if needed, and/or stopping or pausing a video clip. As shown in FIG. 6, the large visual section, or shape entry section, of the screen-shot displays frame number 34 of the video clip and can be on which a shape overlay is defined and/or created. Five frames are displayed in sequence below the large visual area, with the current frame being displayed shown as selected, along with play and stop buttons. Below the play and stop buttons can be shape-builder program function buttons, such as add, delete, view, update, done, etc., as shown. Other sections of the screen-shot include a shape tools section, a shape type section, a shape title section, a shape description section and a shape category section. Other identifying sections or functions may also be included, such as one or more sub-categories, shape starting point, shape ending point, other shape defining characteristics, frame skip or back buttons, etc., but are not shown in FIG. 6 so as to not clutter the descriptive intent of the illustration.

The large visual section, which in FIG. 6 displays frame number 34, is the interactive shape entry or shape building, section. Any shape may be created or defined with this frame display, either as an overlay of a visual element with the frame, or as a stand-alone shape within the frame. The shapes created on, within or for the frame, can ultimately be associated with any advertising elements (as discussed herein). The shape tools section can be where one or more basic shapes may be selected, such as circle, oval, square, rectangle, line, and so on. The shapes section displays or defines the type of shape being drawn or used. The title, description and category sections can be used to identify the particular shape overlay that is being drawn, created or defined. In addition to the shape tools shown, it is contemplated that other tools, such as shape format, line width, line color, fill pattern, fill color, text, text color, text format, and so on, may be used.

In use, the shape-builder program can be a two-fold interaction, both frame-based and/or time-based. That is, creating the shapes can be accomplished on a frame-by-frame basis, and/or by pressing play and moving a shape around in time, logging the position and current points of the shape both in time and frame. Note that the play feature for a video clip can be set to a given frame rate, to aid in accuracy of shape creation (i.e., the playing frame rate might be slower than or faster than a normal playing frame rate). As shown in FIG. 6, a shape overlay has already been drawn over the woman's shirt in the large displayed area that shows frame number 34. The shape type is shown as a polygon, with a title as a tank-top shirt. The shape description is woman's splendid, very light ruffle, tank, and the shape category is clothing.

As previously mentioned, with the tank-top polygon drawn on frame number 34, the play button may be pressed so that the next frames are displayed and as the woman (and hence, the shirt) move slightly through the next frames, the tank-top polygon can be positioned over the woman's shirt, thereby easily defining the shape in many more frames. Finally, after the desired shape overlays have been created for a particular visual media, the done button may be selected to complete the session of shape building.

The screen-shot of FIG. 6 is for illustrative purposes, to teach those skilled in the art how shape-based advertising shape building may be accomplished, and is not meant to limit the shape-builder program to any particular screen layout or inclusion (or exclusion) of any particular shape-building functionality or feature.

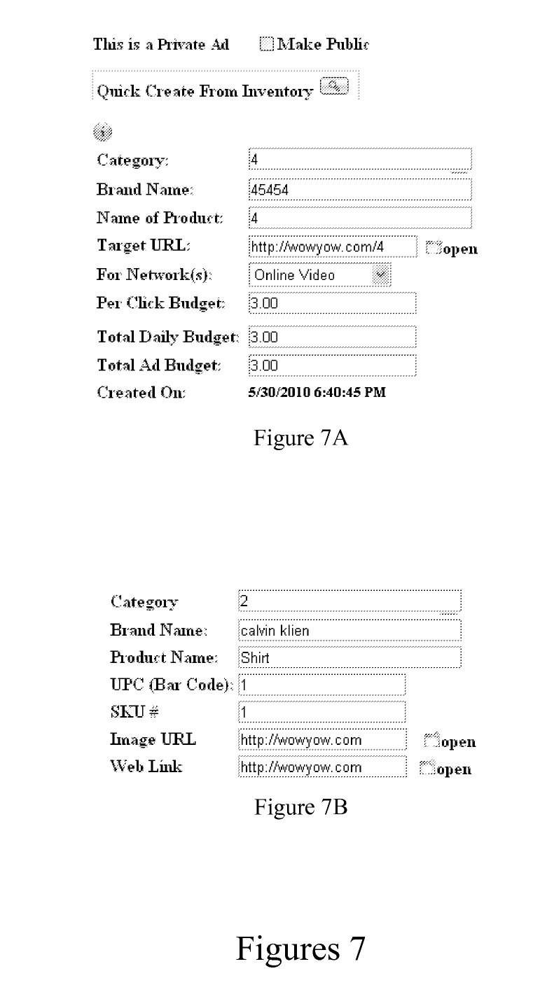

FIG. 7 illustrate exemplary screen-shots depicting shape-based advertisement entry screen and inventory entry screen according to certain embodiments. Shape-based advertising entry, as shown in FIG. 7A, may be accomplished at the same time as the shape building, or may be accomplished at a different time than the shape building. Likewise, inventory entry, as shown in FIG. 7B, may be accomplished at the same time as the shape building, or may be accomplished at a different time than the shape building.

As shown in FIG. 7A, many text fields may be used to help define a shape-based advertisement. For example, a category field can define the type of advertisement being created, such as: 1 for electronics, 2 for clothing, 3 for sporting goods, 4 for furniture, and so on. Brand name and name of product entry fields may also be used to identify the item and/or service being advertised. These fields can be the actual names of the brand and/or product, or may be codes that represent the actual brand and/or product. The target web address, or uniform resource locator (URL), can also be provided for the advertisement. The target URL will be used to direct the user who selects the shape-based advertisement to the desired advertisement. The target URL may be a general website, or a particular product webpage, or an additional webpage of vendor advertisements. The desired network(s) on which the advertisement may be shown/viewed may also be selected, such as for online videos, and so on. An entry created-on date and time may be auto-filled, or manually entered, as well.

Also, the advertisement budgets may be chosen. As illustrated in FIG. 7A, per-click, total daily, and total ad budgets may be entered. However, more or fewer types of budget limits may be used. Default values may be entered for these budgets, or values can be manually entered and might depend on the advertiser's own business budget limitations for this (and other) advertisements and marketing. These budget fields, and others if used, can be used to limit when and/or how frequently the advertisement is displayed along with a shape or shape overlay. Additionally, but not shown, other means for limiting advertisement display frequency may be used, such as a limit counter or a show once every particular number of viewings parameter.

Finally, the advertisement can be either a private ad or a public ad (or, perhaps, a semi-private ad, with limited public aspects). In this context, for example, a private ad would be one that is used for private videos on a particular website and for that website's visual images only. For example, a national chain store may want its on-line videos to only contain its shape-based advertisements. These would be considered private ads. Likewise, an ad may be public, and used on any visual media, regardless of the source and/or location of the visual media.

Additionally, or alternatively, a new advertisement may be created based on an existing advertisement. In this manner, the quick create from inventory button may be selected and the inventory searched and an existing advertisement chosen, which may populate the fields with the chosen advertisement's information. This existing information may be modified, or not, and a new advertisement created from it. For example, a new advertisement with different budgets may be created by basing it on an existing advertisement, but with modified budget limits entered.

As shown in FIG. 7B, many text fields may be used to help define a shape-based advertising inventory. For example, a category field can define the type of shape or advertisement being created in the inventory of shapes or advertisements, such as: 1 for electronics, 2 for clothing, 3 for sporting goods, 4 for furniture, and so on. Brand name and name of product entry fields may also be used to identify the item and/or service being advertised. These fields can be the actual names of the brand and/or product, or may be codes that represent the actual brand and/or product. The UPC (or, Universal Product Code) and SKU (or, Stock-Keeping Unit) fields are used to help further identify the inventory being entered. The Image URL can be used to direct the advertisement and/or shape to a brand/product image, and the web link URL may be a general website, or a particular product webpage, or an additional webpage of vendor advertisements or brand/product description.

The screen-shots of FIG. 7 are for illustrative purposes, to teach those skilled in the art how shape-based advertisement entry and inventory entry may be accomplished, and are not meant to limit the shape-based advertisement entry or inventory entry program to any particular screen layout or inclusion (or exclusion) of any particular entry field, functionality or feature.

In certain embodiments, a particular product in some visual media for which shape-based advertisement has been targeted can be identified in a hierarchically-linked manner. For example, the product may be linked using a stock-keeping unit (SKU) Brand Category hierarchy, along with a separate title and description, perhaps to aid in searching for the product. It is noted that many different hierarchical approaches for linking products to shapes to advertisements may be used, as well as non-hierarchical approaches. Additionally, the identification or linking between products, shapes and advertisements does not have to occur on a particular input screen, as, for example, those screens shown in FIGS. 6 and 7. The identification or linking can be accomplished in the background of the overall system or even on another input screen page of the system. However, once the shape is related to the image, the two can be recalled at any time for identification.

As an example, the code below illustrates a particular visual image, in this case a frame of a video, and its associated shapes and linked advertisements.

```
<frame number=”23” image=”23.png” width=”720” height=”480”
<figures>
<area shape=”polygon” cords=” x1,y1,x2,y2,x3,y3,x4,y4,x5,y5,x1,y1”
  id=”1” category=”furniture”
<area shape=”polygon” cords=” a1,b1,a2,b2,a3,b3,a4,b4,a5,b5,a1,b1”
  id=”4” category=”clothing”
</figures>
<buylinks>
<buylink>http://buylink1.com<buylink>
<buylink>http://buylink4.com<buylink>
</buylinks>
```

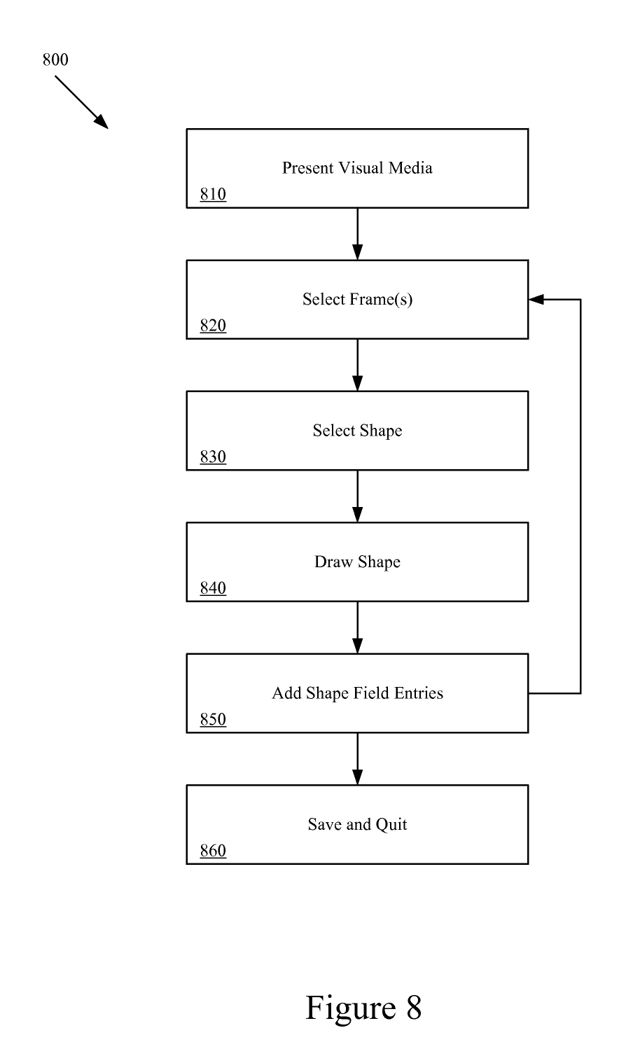

FIG. 8 illustrates an exemplary process 800 of shape building for shape-based advertising according to certain embodiments. In certain embodiments, as shown in FIG. 8, the shape building process is a manual process, where each shape is built onto each frame of the visual media. However, in certain embodiments, it is possible to build shapes on a moving, or playing, piece of visual media, instead of, or in combination with, on a frame-by-frame basis. Additionally, in certain embodiments, the shape building process, or portions of it, may be automated, so that manual interaction with the process is minimized or even eliminated.

Initially, at step 810, a piece of visual media is presented to user 110 on display device 130. In certain embodiments, the presentation may be via a shape builder program, as illustrated, for example, in FIG. 6, which may be part of computing device 140. As with all pieces of this disclosure, it is possible to break away the shape building process to a stand-alone system, and then integrate the end-result of the shape building process at a later instance. The visual media may be variably accessible by user 110 via the builder, for example, on a frame-by-frame basis or in a slow-motion mode.

At step 820, a particular frame (or set of frames) is selected. In certain embodiments, a single frame is displayed, on which shapes may be built. User 110 may next select a shape to build on the selected frame, as illustrated by step 830, for example using input device 120. The shape may be of any type, for example, circle, square, line, arc, polygon, free-form, etc. User 110 can use the various shapes to draw on top of (e.g., outline) any shape in the selected frame for which a shape-based advertisement may be desired, as shown at step 840. Additionally, user 110 may draw shapes not corresponding to any shape in the selected frame to provide general advertising regarding the selected frame. For example, user 110 may draw a square shape in the upper right-hand corner of the selected frame, which may be used to provide advertisements regarding the geographic location depicted in the frame, the photographer of the frame, the copyright/trademark owner of the frame, or the like.

As step 850, shape entries are entered. In certain embodiments, shape entries such as the title, description and category may be entered by user 110. Other identifying shape information may be entered, either in addition to, or in exchange for, the entries listed above. At this point in the process, either additional shapes may be built on the same frame, or a new frame may be selected and one or more shapes built on the newly selected frame, or user 110 may save the shapes built on the visual media and quit the building process, as shown at step 860.

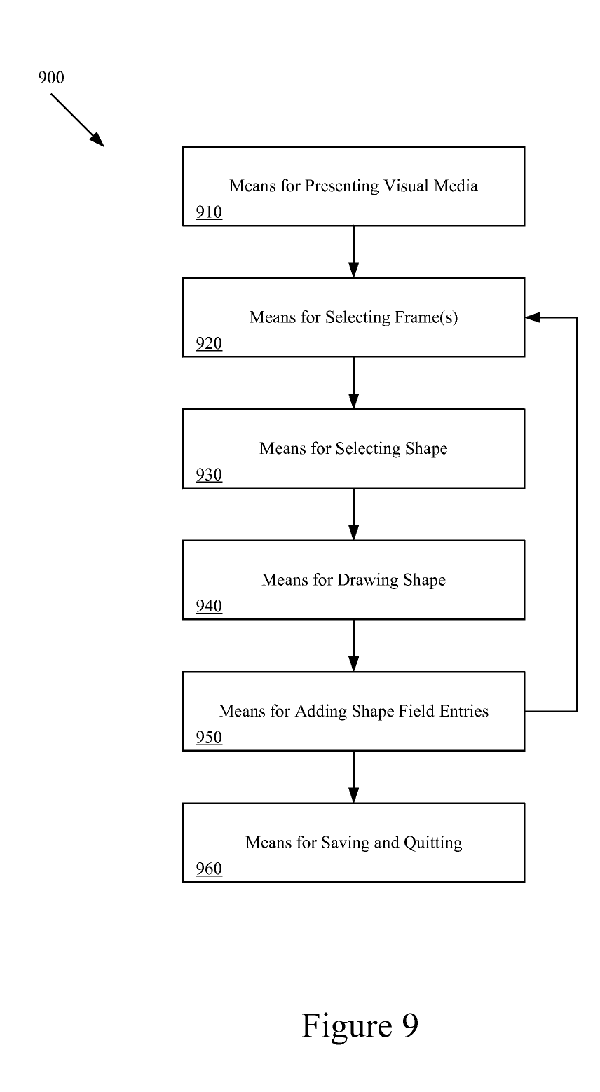

FIG. 9 illustrates an exemplary hardware implementation 900 of shape building for shape-based advertising according to certain embodiments. As shown in FIG. 9, blocks 910-960 correspond to hardware implementation of the exemplary process illustrated in steps 810-860 and the corresponding disclosure. Some or all of block 910-960 may be performed by hardware disclosed throughout this application, either with or without accompanying software/firmware/code, or other hardware as may be equivalent to the disclosed hardware.

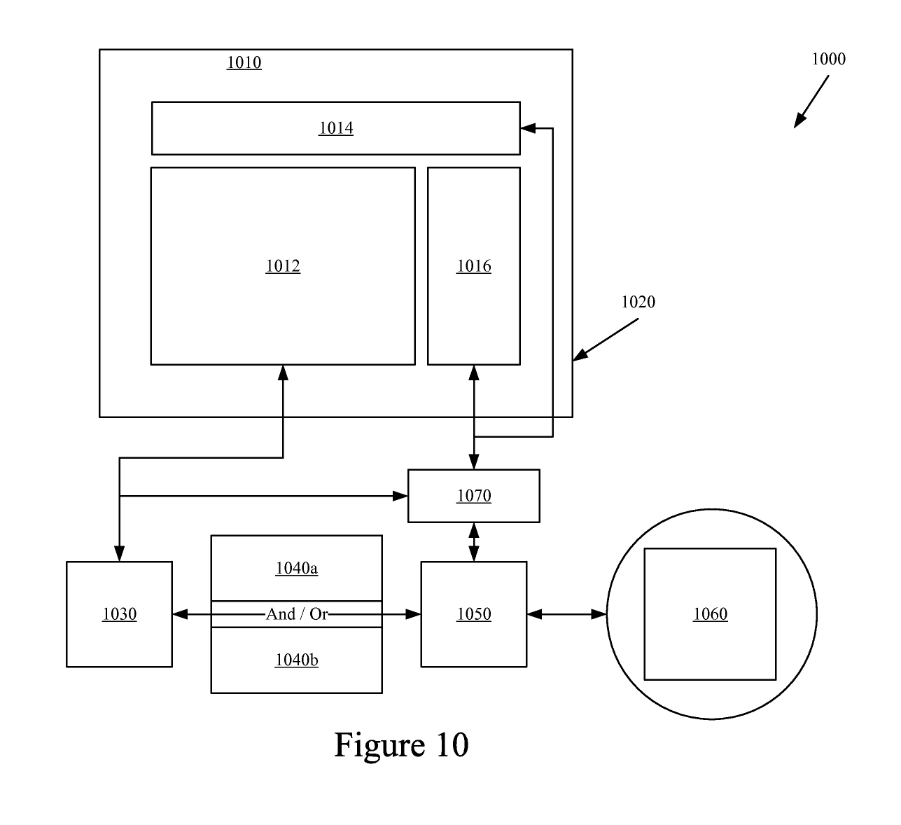

FIG. 10 illustrates an exemplary system and process 1000 for temporal-based, visual media advertising according to certain embodiments. As shown in FIG. 10, an example website 1010, e.g., Website.com, is being viewed on a web-page using any kind of viewing device 1020. Device 1020 may be, for example, a tablet device connected to the Internet using a broadband wireless connection. Of course, any other type of device and connection may be used. On website 1010, a video 1012 is playing. Also on the page there exists a banner advertisement 1014 across the top of the page and a sidebar advertisement 1016 along the right side of the page. There might be additional advertisement sections or fewer, and all may be text-only or include some sort of graphic and/or visual effects.

In certain embodiments, there can be a video player 1030 used for presenting playing video 1012 to website 1010. Video player 1030 may be hardware and/or software, or a combination of both, and may be combined with, or separate from, web-page viewing device 1020. Video player 1030 can provide a time stamp 1040a of the particular video being played, along with, perhaps, additional video identifying information, and/or it can provide a frame number 1040b, together with, perhaps, the additional video identifying information. These data may be supplied to additional software and/or web scripts 1050 that may be used for supplying the banner and sidebar ads to the web-page.

In certain embodiments, the software and/or web scripts 1050 may pass along the video data supplied by the video player to an advertisement server and a time/frame lookup server 1060. These servers 1060 may look up the particular portion of the video being played at that particular time and/or frame (or, for example, an upcoming time and/or frame of that video) and determine one or more particular characteristics for that video (i.e., at that particular time and/or frame or an upcoming time/frame) and one or more relevant advertisements associated with that/those particular characteristic(s) of that video. Then, the one or more relevant advertisement(s) can be supplied to the software and/or web scripts 1050, which can then send them to the web-page for presentation 1070 at or about the relevant time and/or frame the video is playing. The software and/or web script 1050 may coordinate with video player 1030 to coordinate 1070 the presentation of relevant advertisement(s) at the appropriate time and/or frame. This presentation and/or coordination may be part of device 1020, video player 1030, server 1060, or functionally divided between two or more of these three. In this way, banner ad 1014 and/or sidebar ad 1016 can be similar to or matching the content of playing video 1012.

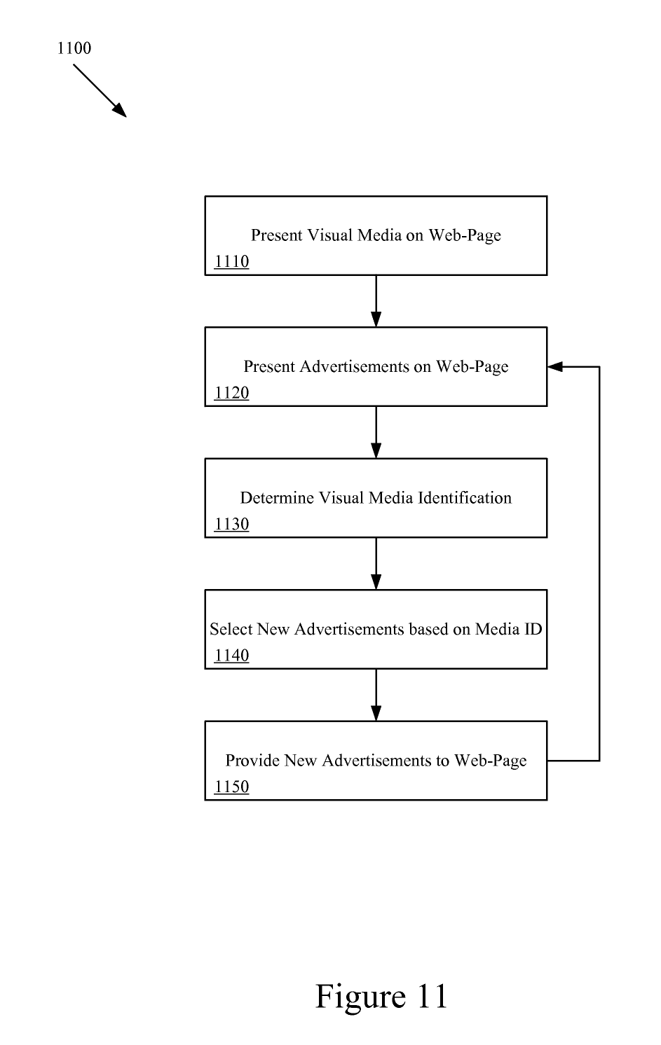

FIG. 11 illustrates an exemplary process for visual media-based advertising according to certain embodiments. At step 1110, a piece of visual media is presented, for example, on a web-page of a computer, smart phone or tablet view screen. At step 1120, along with or in addition to the visual media, the web-page may present advertisements on the view screen. For example, banner ads and/or sidebar ads may be presented.

As step 1130, an identification (or ID) for the visual media is determined. For example, this identification may include a time stamp for where the media or a frame number for the media, along with, perhaps, a name or number for the media itself. The media ID may be a current ID for the media, or it may be a project future ID for the media, such that the media ID may project into the future, either a little or a lot, what part of the media will be presented at some future point in time (or in frame count or number). As will become clear to those skilled in the art upon learning from this disclosure, any types of media identification may be used.

At step 1140, one or more new advertisements can be selected based at least on the media ID determined in step 1130. In this way, for example, the new advertisements may be somehow related to, or relevant to, the media that is being (or the projected demographic of the viewer of the media), or will be, presented on the view screen. Then, these new advertisements may be provided back to the web-page at step 1150, for presentation on the web-page at step 1120. This cycle may continue as long as the media is being presented and/or as long as desired by the system (e.g., for a predetermined and/or random amount of time) and/or as long as the advertisements remain related to, or relevant to, the media being presented (or the projected demographic of the viewer of the media).

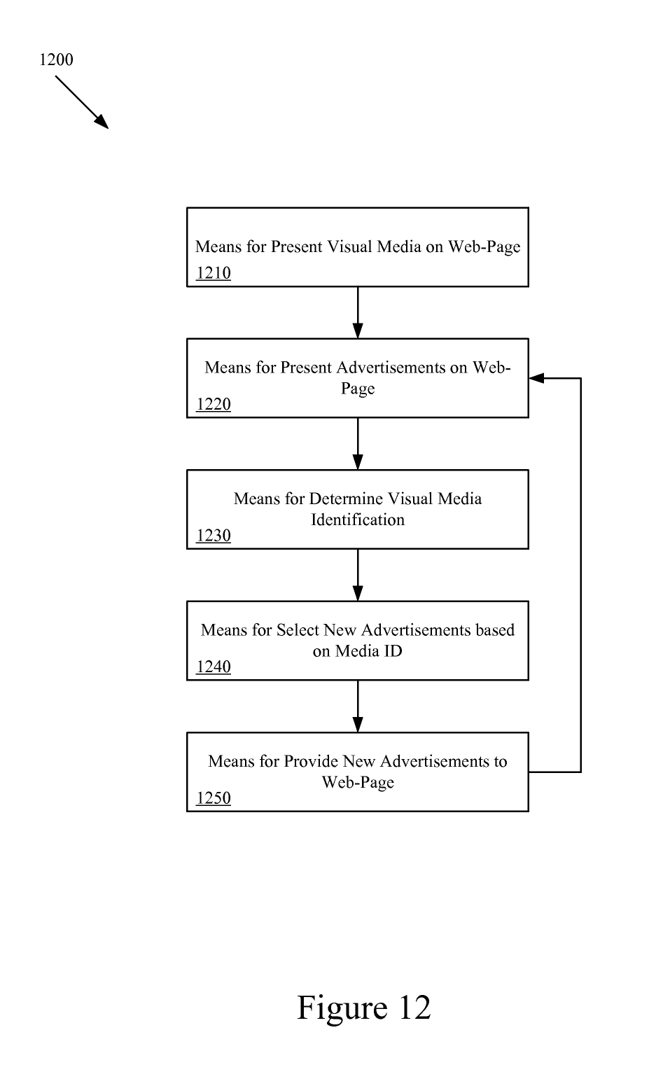

FIG. 12 illustrates an exemplary hardware implementation for visual media-based advertising according to certain embodiments. As shown in FIG. 12, blocks 1210-1250 correspond to hardware implementation of the exemplary process illustrated in steps 1110-1150 and the corresponding disclosure. Some or all of block 1210-1250 may be performed by hardware disclosed throughout this application, either with or without accompanying software/firmware/code, or other hardware as may be equivalent to the disclosed hardware.

### CONCLUSION

While, generally, the embodiments disclosed herein have been described in terms of a video. These descriptions are strictly by way of examples only and are not meant to limit the scope of the overall disclosed concepts. For example, the concepts herein are equally applicable to all types of media and in all settings. For example, video games and full length Blu-ray™ movies can benefit from the concepts disclosed herein. Likewise, any visual media that has the possibility for viewer interaction may benefit from the concepts disclosed herein.

Those of ordinary skill in the art will understand, after being taught by this disclosure, that the various steps and devices may be combined into one or more devices performing all or some of the functions described herein. Further, the use of video and frame is not meant to restrict the scope of the claims, but is used for illustrative purposes only. The techniques described are equally applicable to any and all types of visual media. Additionally, all manual input and/or calculations are intended to be understood as capable of being performed automatically.

Those of ordinary skill would further appreciate that the various illustrative logical blocks, modules, and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in one or more software modules executed by one or more processing elements, or in a combination of the two. A software module may reside in RAM memory, flash memory, ROM memory, EPROM memory, EEPROM memory, registers, hard disk, a removable disk, a CD-ROM, or any other form or combination of storage medium known in the art. An example storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples and additional elements may be added.

### Additional Embodiments

### Embodiment A

A method for shape-building for shape-based advertising for electronic visual media comprising: selecting a frame of the electronic visual media; building a shape associated with the frame of the electronic visual media; and adding shape entries for the built shape.

The method of embodiment A, further comprising presenting the electronic visual media on a display device prior to selecting the frame.

The method of embodiment A, wherein building the shape includes selecting the shape that approximates at least a portion of the frame from a group of pre-defined shapes.

The method of embodiment A, wherein building the shape includes tracing the shape that approximates at least a portion of the frame.

The method of embodiment A, wherein building the shape includes defining coordinates of the shape that approximates at least a portion of the frame.

The method of embodiment A, wherein the shape entries include at least one item selected from a group of items, the group of items including: an electronic visual media identifier; one or more frame numbers; a shape title; one or more shape descriptors; one or more shape categories; a target URL; a brand name; and one or more advertising budgets.

### Embodiment B

A system for shape-building for shape-based advertising for electronic visual media comprising: a selector apparatus for selecting a frame of the electronic visual media; a builder apparatus for building a shape associated with the frame of the electronic visual media; and an adder apparatus for adding shape entries for the built shape.

The system of embodiment B, further comprising a presentation apparatus for presenting the electronic visual media on a display device prior to selecting the frame.

The system of embodiment B, wherein building the shape includes selecting the shape that approximates at least a portion of the frame from a group of pre-defined shapes.

The system of embodiment B, wherein building the shape includes tracing the shape that approximates at least a portion of the frame.

The system of embodiment B, wherein building the shape includes defining coordinates of the shape that approximates at least a portion of the frame.

The system of embodiment B, wherein the shape entries include at least one item selected from a group of items, the group of items including: an electronic visual media identifier; one or more frame numbers; a shape title; one or more shape descriptors; one or more shape categories; a target URL; a brand name; and one or more advertising budgets.

### Embodiment C

An apparatus for shape-building for shape-based advertising for electronic visual media comprising: means for selecting a frame of the electronic visual media; means for building a shape associated with the frame of the electronic visual media; and means for adding shape entries for the built shape.

The apparatus of embodiment C, further comprising means for presenting the electronic visual media on a display device prior to selecting the frame.

The apparatus of embodiment C, wherein the means for building the shape includes means for selecting the shape that approximates at least a portion of the frame from a group of pre-defined shapes.

The apparatus of embodiment C, wherein the means for building the shape includes means for tracing the shape that approximates at least a portion of the frame.

The apparatus of embodiment C, wherein the means for building the shape includes means for defining coordinates of the shape that approximates at least a portion of the frame.

The apparatus of embodiment C, wherein the shape entries include at least one item selected from a group of items, the group of items including: an electronic visual media identifier; one or more frame numbers; a shape title; one or more shape descriptors; one or more shape categories; a target URL; a brand name; and one or more advertising budgets.

### Embodiment D

A computer-program storage apparatus for shape-building for shape-based advertising for electronic visual media comprising at least one memory having one or more software modules stored thereon, the one or more software modules being executable by one or more processors and the one or more software modules comprising: code for selecting a frame of the electronic visual media; code for building a shape associated with the frame of the electronic visual media; and code for adding shape entries for the built shape.

The computer-program storage apparatus of embodiment D, further comprising code for presenting the electronic visual media on a display device prior to selecting the frame.

The computer-program storage apparatus of embodiment D, wherein the code for building the shape includes code for selecting the shape that approximates at least a portion of the frame from a group of pre-defined shapes.

The computer-program storage apparatus of embodiment D, wherein the code for building the shape includes code for tracing the shape that approximates at least a portion of the frame.

The computer-program storage apparatus of embodiment D, wherein the code for building the shape includes code for defining coordinates of the shape that approximates at least a portion of the frame.

The computer-program storage apparatus of embodiment D, wherein the shape entries include at least one item selected from a group of items, the group of items including: an electronic visual media identifier; one or more frame numbers; a shape title; one or more shape descriptors; one or more shape categories; a target URL; a brand name; and one or more advertising budgets.

Embodiment E. A method for advertising for electronic visual media on a web-page, comprising: determining at least one electronic visual media identifier (ID) for the electronic visual media; selecting at least one shape-based advertisement based at least on the electronic visual media ID; selecting at least one web-page advertisement based at least on the electronic visual media ID; presenting the at least one shape-based advertisement in conjunction with presenting the electronic visual media; and presenting the at least one advertisement on the web-page in conjunction with presenting the electronic visual media.

Embodiment F. A system for advertising for electronic visual media on a web-page, comprising: a video player for determining at least one electronic visual media identifier (ID) for the electronic visual media; a server for selecting at least one shape-based advertisement based at least on the electronic visual media ID and for selecting at least one web-page advertisement based at least on the electronic visual media ID; an apparatus for presenting the at least one shape-based advertisement in conjunction with presenting the electronic visual media; and an apparatus for presenting the at least one advertisement on the web-page in conjunction with presenting the electronic visual media.

### Embodiment G

An apparatus for advertising for electronic visual media on a web-page, comprising: means for determining at least one electronic visual media identifier (ID) for the electronic visual media; means for selecting at least one shape-based advertisement based at least on the electronic visual media ID; means for selecting at least one web-page advertisement based at least on the electronic visual media ID; means for presenting the at least one shape-based advertisement in conjunction with presenting the electronic visual media; and means for presenting the at least one advertisement on the web-page in conjunction with presenting the electronic visual media.

### Embodiment H

A computer-program storage apparatus for advertising for electronic visual media on a web-page comprising at least one memory having one or more software modules stored thereon, the one or more software modules being executable by one or more processors and the one or more software modules comprising: code for determining at least one electronic visual media identifier (ID) for the electronic visual media; code for selecting at least one shape-based advertisement based at least on the electronic visual media ID; code for selecting at least one web-page advertisement based at least on the electronic visual media ID; code for presenting the at least one shape-based advertisement in conjunction with presenting the electronic visual media; and code for presenting the at least one advertisement on the web-page in conjunction with presenting the electronic visual media.

What is claimed is:

1. A method for shape-based advertising for electronic visual media comprising:
capturing the electronic visual media;
identifying the electronic visual media information associated with the electronic visual media;
communicating the electronic visual media information;
analyzing the electronic visual media information for association with the shape-based advertising; and
presenting the shape-based advertising together with the electronic visual media on an electronic device.

2. The method of claim 1, wherein the electronic visual media is a video and the captured electronic visual media is a frame of the video.

3. The method of claim 1, wherein the electronic visual media information includes at least one item selected from a group of items, the group of items including:
a unique identifier for the electronic visual media;
one or more presentation dimensions associated with the electronic visual media; and
one or more time components associated with the electronic visual media.

4. The method of claim 1, further comprising communicating the shape-based advertising prior to presenting the shape-based advertising.

5. The method of claim 4, wherein analyzing the electronic visual media information includes:
receiving the electronic visual media information;
searching, using at least the electronic visual media information, for one or more overlay shapes associated with the electronic visual media;
searching, using at least the electronic visual media information, for promotional information relevant to the electronic visual media; and
correlating, if found, the overlay shapes and the promotional information with the electronic visual media information.

6. A system for shape-based advertising for electronic visual media comprising:
a media player for capturing the electronic visual media and identifying the electronic visual media information associated with the electronic visual media;
a promotional information server for receiving the electronic visual media information; and
a promotional information calculator for analyzing the electronic visual media information for association with the shape-based advertising,
wherein the media player presents the shape-based advertising together with the electronic visual media on an electronic device.

7. The system of claim 6, wherein the electronic visual media is a video and the captured electronic visual media is a frame of the video.

8. The system of claim 6, wherein the electronic visual media information includes at least one item selected from a group of items, the group of items including:
a unique identifier for the electronic visual media;
one or more presentation dimensions associated with the electronic visual media; and
one or more time components associated with the electronic visual media.

9. The system of claim 6, wherein the media player receives the shape-based advertising prior to presenting the shape-based advertising.

10. The system of claim 9, wherein the promotional information calculator analyzing the electronic visual media information includes:
receiving the electronic visual media information;
searching, using at least the electronic visual media information, for one or more overlay shapes associated with the electronic visual media;
searching, using at least the electronic visual media information, for promotional information relevant to the electronic visual media; and
correlating, if found, the overlay shapes and the promotional information with the electronic visual media information.

11. An apparatus for shape-based advertising for electronic visual media comprising:
means for capturing the electronic visual media;
means for identifying the electronic visual media information associated with the electronic visual media;
means for communicating the electronic visual media information;
means for analyzing the electronic visual media information for association with the shape-based advertising; and
means for presenting the shape-based advertising together with the electronic visual media on an electronic device.

12. The apparatus of claim 11, wherein the electronic visual media is a video and the captured electronic visual media is a frame of the video.

13. The apparatus of claim 11, wherein the electronic visual media information includes at least one item selected from a group of items, the group of items including:
a unique identifier for the electronic visual media;
one or more presentation dimensions associated with the electronic visual media; and
one or more time components associated with the electronic visual media.

14. The apparatus of claim 11, further comprising means for communicating the shape-based advertising prior to presenting the shape-based advertising.

15. The apparatus of claim 14, wherein the means for analyzing the electronic visual media information includes:
means for receiving the electronic visual media information;
means for searching, using at least the electronic visual media information, for one or more overlay shapes associated with the electronic visual media;
means for searching, using at least the electronic visual media information, for promotional information relevant to the electronic visual media; and
means for correlating, if found, the overlay shapes and the promotional information with the electronic visual media information.

16. A computer-program storage apparatus for shape-based advertising for electronic visual media comprising at least one memory having one or more software modules stored thereon, the one or more software modules being executable by one or more processors and the one or more software modules comprising:
code for capturing the electronic visual media;
code for identifying the electronic visual media information associated with the electronic visual media;
code for communicating the electronic visual media information;
code for analyzing the electronic visual media information for association with the shape-based advertising; and
code for presenting the shape-based advertising together with the electronic visual media on an electronic device.

17. The computer-program storage apparatus of claim 16, wherein the electronic visual media is a video and the captured electronic visual media is a frame of the video.

18. The computer-program storage apparatus of claim 16, wherein the electronic visual media information includes at least one item selected from a group of items, the group of items including:
a unique identifier for the electronic visual media;
one or more presentation dimensions associated with the electronic visual media; and
one or more time components associated with the electronic visual media.

19. The computer-program storage apparatus of claim 16, further comprising code for communicating the shape-based advertising prior to presenting the shape-based advertising.

20. The computer-program storage apparatus of claim 19, wherein the code for analyzing the electronic visual media information includes:
code for receiving the electronic visual media information;
code for searching, using at least the electronic visual media information, for one or more overlay shapes associated with the electronic visual media;
code for searching, using at least the electronic visual media information, for promotional information relevant to the electronic visual media; and
code for correlating, if found, the overlay shapes and the promotional information with the electronic visual media information.
